(19) United States
(12) Patent Application Publication
(10) Pub. No.: US 2026/0287085 A1
(43) Pub. Date: Sep. 24, 2026

(54) VALVE OPEN/CLOSE POSITION DETECTION DEVICE, AND METHOD FOR STARTING VALVE OPEN/CLOSE POSITION LEARNING PROGRAM

(71) Applicant: TOMOE VALVE CO., LTD., Osaka (JP)

(72) Inventors: Masato SUGA, Hyogo (JP); Kiyoji YOSHIDA, Nara (JP)

(21) Appl. No.: 19/479,387

(22) PCT Filed: May 23, 2024
(86) PCT No.: PCT/JP2024/019054

§ 371 Date: Oct. 28, 2025

(30) Foreign Application Priority Data
Jun. 15, 2023 (JP) 2023-098643

(51) Int. Cl. F16K 37/00

(52) U.S. Cl. CPC F16K 37/0033

(57) ABSTRACT

A valve opening and closing position detector for remotely monitoring a state of a valve is provided for easily grasping the angle and position at full closing of the valve and the angle and position at full opening of the valve, for example. The valve opening and closing position detector according to the present disclosure includes a magnetic angle sensor that detects an operation angle of a valve based on a magnetic field generated by a magnet that rotates in accordance with a rotational operation of the valve and a processor. The processor is configured to execute a program for learning opening and closing positions by storing in a memory a plurality of angles of the magnet rotated in accordance with opening and closing operations of the valve. In the valve opening and closing position detector, the processor activates the program for learning opening and closing positions in response to elapse of a predetermined time after an occurrence of a state in which the magnetic angle sensor does not detect the magnet.

### TECHNICAL FIELD

The present disclosure relates to a valve opening and closing position detector and a method for activating a program for learning opening and closing positions of a valve.

### BACKGROUND ART

Valves are used in various places in various plants and factories. The valve to be used is required to be continuously and stably operated for a long period after being incorporated into a plant or factory equipment. However, the incorporated valve is often disposed at or in a position, a place, or an environment where it is difficult for an operator or an inspector to directly contact the incorporated valve.

Therefore, recently, a valve state monitoring device has been developed that monitors the soundness of operation of a plant or factory equipment by remotely monitoring the state of a valve and thereby contributes to prevention of sudden trouble and failure.

### PRIOR ART DOCUMENT

### Patent Document

Patent Document 1: JP-A-2018-73154

Patent Document 2: JP-A-2019-191760

Patent Document 3: JP-A-2004-169887

### SUMMARY OF THE INVENTION

### Problems to be Solved by the Invention

It is required that a valve state monitoring device for remotely monitoring a state of a valve can easily grasp an angle and position related to opening and closing of the valve, for example, an angle and position at full closing of the valve and an angle and position at full opening of the valve.

### Solutions to the Problems

A valve opening and closing position detector of the present disclosure includes a magnetic angle sensor that detects an operation angle of a valve based on a magnetic field generated by a magnet that rotates in accordance with a rotational operation of the valve and a processor. The processor is configured to execute a program for learning opening and closing positions by storing in a memory a plurality of angles of the magnet rotated in accordance with opening and closing operations of the valve. In the valve opening and closing position detector, the processor activates the program for learning opening and closing positions in response to elapse of a predetermined time after an occurrence of a state in which the magnetic angle sensor does not detect the magnet.

### Effects of the Invention

By using the valve opening and closing position detector and/or the method for activating a program for learning opening and closing positions of a valve of the present disclosure, the valve state monitoring device can easily grasp the angle and position related to the opening and closing of the valve. For example, the valve state monitoring device can easily grasp the angle and position at full closing of the valve and the angle and position at full opening of the valve. This enables the valve state monitoring device to remotely monitor the state of the valve.

### BRIEF DESCRIPTION OF THE DRAWINGS

FIG. 1 is a block diagram illustrating a configuration of a valve opening and closing position detector according to an embodiment and peripheral devices.

FIG. 2A is a perspective view of the valve opening and closing position detector according to the embodiment.

FIG. 2B is a perspective view of a configuration containing the valve opening and closing position detector 2 according to the embodiment, a cylinder 12, and a valve unit 22.

FIG. 2C is a partially enlarged view of the configuration in the broken-line frame illustrated in FIG. 2B.

FIG. 3 is a top view of the cylinder on an upper part of the valve unit, and shows an opening degree indicator unit and, in particular, a sensor magnet (magnet) that is configured to rotate in accordance with an operation of the cylinder and further with a rotational operation of a valve body (valve) in the valve unit.

FIG. 4 is a flowchart of a process, in an opening and closing position learning mode, of the valve opening and closing position detector according to the embodiment.

FIG. 5 is a flowchart of a procedure of the automatic recovery learning process, of the valve opening and closing position detector according to the embodiment, for automatically transitioning to the opening and closing position learning mode.

FIG. 6A is a schematic cross-sectional view of a three-way valve.

FIG. 6B is a schematic cross-sectional view illustrating, with respect to the three-way valve, positions (1) to (4) of a ball valve and a state of a flow path at each time.

### DETAILED DESCRIPTION

Embodiments will be described in detail with reference to the drawings as appropriate. However, unnecessarily detailed description may be omitted. For example, a detailed description of already well-known matters and repeated description of substantially the same configuration may be omitted. This is to prevent the following description from being unnecessarily redundant and to facilitate those skilled in the art to understand the present disclosure.

Note that the inventors provide the accompanying drawings and the following description in order for those skilled in the art to fully understand the present disclosure, and does not intend to limit subject matters recited in the claims.

### 1. Background to the Present Disclosure

The valve opening and closing position detector in the present disclosure is also referred to as a valve state monitoring device. The valve state monitoring device is a monitoring unit for, for example, remotely monitoring the state of a valve, and is a data logger that records a profile over time for an angle related to the opening and closing of the valve.

The valve opening and closing position detector uses a magnetic angle sensor having a sensor magnet in order to monitor in real time a position corresponding to opening and closing operations of the valve, in other words, a change in an angle, with respect to the flow path, of the valve between a fully opened state and a fully closed state. The magnetic angle sensor here is, for example, a tunneling magneto resistance (TMR) sensor. The valve state monitoring device monitors in real time a change in angle due to the opening and closing operation of the valve by using the magnetic angle sensor, and takes a data log of the change in angle as an angle profile and stores the data log in a memory.

When the valve opening and closing position detector operates, there is a necessary process for each individual valve as a kind of initial setting. Specifically, when the valve is opened and closed, for example, when the valve is fully opened and is fully closed, a rotation angle of the sensor magnet is determined and recorded in a memory of the valve opening and closing position detector. Recording of the angle of the sensor magnet having rotated in accordance with the opening and closing of the valve in the memory of the valve opening and closing position detector is referred to as “opening and closing position learning” in the present specification. The main reason why the opening and closing position learning is performed for each individual valve is described in the following (1) and (2).

(1) An operation range from a fully closed state to a fully opened state is different for each valve.

It is assumed that the operation range from the fully opened state to the fully closed state of a valve is designed to be, for example, 90°. Components constituting a valve and an actuator include machining tolerances and the like; therefore, in a valve, which is an industrial product, the operation range between the fully opened state and the fully closed state is not always 90°. For example, the operation range may have a value of 89°, 89.5°, 90.2°, or the like. In order to accurately and reliably grasp the fully opened state and the fully closed state of the valve by the sensor magnet and the magnetic angle sensor, it is required to grasp the operation range from the fully closed state to the fully opened state for each valve.

(2) Positions of an S-pole and an N-pole of a sensor magnet attached to a cylinder are different between cylinders.

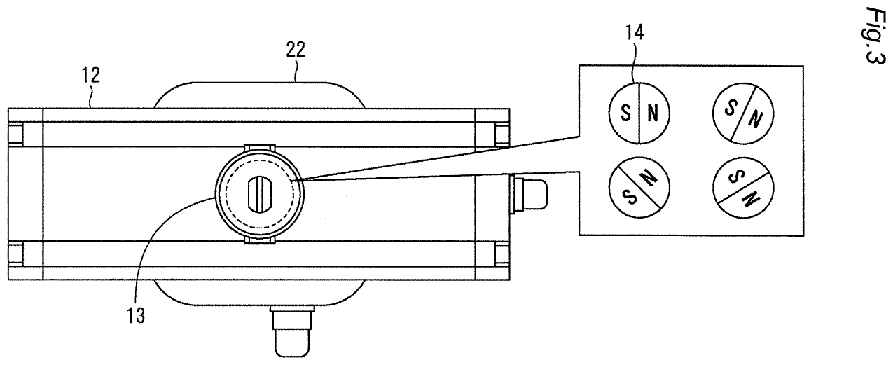

FIG. 3 is a top view of the cylinder 12 on the upper part of the valve unit 22. FIG. 3 illustrates an opening degree indicator unit 13 and, more specifically, illustrates the sensor magnet 14 that is a magnet. The opening degree indicator unit 13 is configured to rotate in accordance with an operation (not illustrated) of the cylinder 12 and further with the rotational operation (not illustrated) of a valve body (valve) in the valve unit 22. The sensor magnet 14 is attached above the cylinder 12 with the opening degree indicator unit 13 interposed between the sensor magnet 14 and the cylinder 12. As found by the inventors of the present application, the positions and directions of the S-pole and the N-pole are not constant but can vary due to an attachment error or the like when the sensor magnet 14 is attached. Therefore, it is required to determine and record the positions and directions (that is, the angles) of the S-pole and N-pole of the sensor magnet 14 in accordance with the opening and closing operation of the valve, for example, when the valve is fully opened and is fully closed.

The opening and closing position learning performed for the reasons described in above (1) and (2) is usually performed by the processor of the valve state monitoring device executing a computer program. The valve state monitoring device may include a wireless line and/or a wired line. The valve state monitoring device receives a command from an external personal computer, tablet terminal, smartphone, or the like via the wireless line or the wired line. As a result, the processor can execute a program for the opening and closing position learning, and the valve state monitoring device enters the “opening and closing position learning mode”.

Therefore, after the sensor magnet (magnet) and the valve state monitoring device are initially installed for the valve and the cylinder, the opening and closing position learning mode is started from an external device via the wireless or wired line by a communication command.

By the way, due to communication circumstances or from the viewpoint of information security, there is a situation in which wireless communication or wired communication cannot be used depending on timing in on-site equipment in which the valve is installed. In that case, in the vicinity of the on-site equipment provided with the valve, a communication command cannot be transmitted from the external device to the valve state monitoring device. In order to switch the valve state monitoring device to the “opening and closing position learning mode”, it is necessary to take a procedure that, for example, a communication command is transmitted from the external terminal to the valve state monitoring device after the valve state monitoring device is sufficiently separated from the on-site equipment provided with the valve. Such a procedure is complicated and also causes an extra cost.

It is required to be able to easily grasp, by the valve state monitoring device, the angles corresponding to opening and closing operations of the valve (that is, magnet), for example, the angle at full closing of the valve and the angle at full opening of the valve. Under such circumstances, the inventors of the present application have conceived the automatic recovery learning, which is the invention according to the present disclosure. A program for this automatic recovery learning realizes automatic transition to the opening and closing position learning mode.

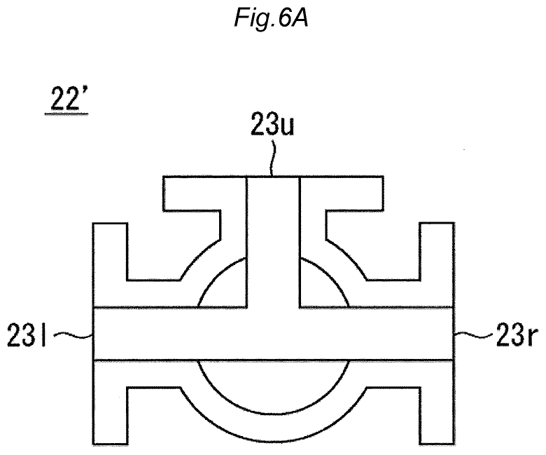

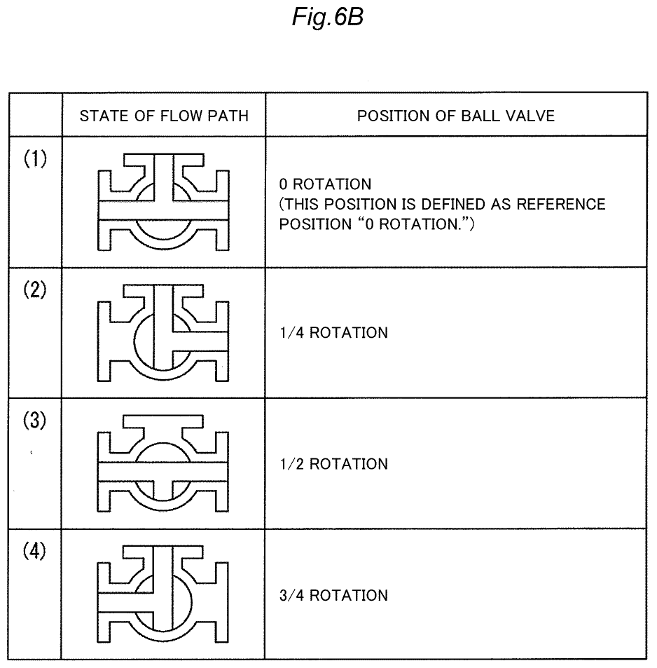

Note that valves called a three-way valve and a five-way valve are also used in various plants and factories. The three-way valve is a type of ball valve, and is a valve provided with fluid inlet/outlet ports in three directions. FIG. 6A is a schematic cross-sectional view of an exemplified three-way valve 22′. The three-way valve 22′ illustrated in FIG. 6A includes a front inlet/outlet port 23u, a right inlet/outlet port 23r, and a left inlet/outlet port 23l. In the three-way valve 22′, the position and angle of the ball valve 22′ may take four states as illustrated in FIG. 6B in order to flow a fluid.

First, in (1) of FIG. 6B, the position and angle of the ball valve 22′ are at zero rotation, and at that time, the fluid flows between the front inlet/outlet port 23u, the right inlet/outlet port 23r, and the left inlet/outlet port 23l.

Furthermore, in (2) of FIG. 6B, the position and angle of the ball valve 22′ are at ¼ rotation, and at that time, the fluid flows between the front inlet/outlet port 23u and the right inlet/outlet port 23r.

Furthermore, in (3) of FIG. 6B, the position and angle of the ball valve 22′ are at ½ rotation, and at that time, the fluid flows between the right inlet/outlet port 23r and the left inlet/outlet port 23l.

Furthermore, in (4) of FIG. 6B, the position and angle of the ball valve 22′ are at ¾ rotation, and at that time, the fluid flows between the left inlet/outlet port 23l and the front inlet/outlet port 23u.

Also in the operation of the opening and closing position detector related to the three-way valve described above, it is essential, for each individual valve, to determine the above-described four positions and angles in rotation of the sensor magnet 14 and to record the positions and angles in the memory of the valve opening and closing position detector. Therefore, also for the three-way valve, a program for the opening and closing position learning can be prepared and be operated in a timely manner.

A five-way valve is also one type of a ball valve, and is a valve provided with fluid inlet/outlet ports in five directions. Also for the five-way valve, a program for the opening and closing position learning can be prepared as a manner of course and be operated in a timely manner.

More generally, an N-way valve (N is a natural number 2 or more) is conceivable. In such a case, it is assumed that the number of positions and angles to be grasped and stored as initial settings is, for example, M (M is a natural number of 2 or more, and is not necessarily equal to N.). Also for such an N-way valve, a program for the opening and closing position learning can be prepared and be operated in a timely manner.

The program for the automatic recovery learning that is the invention according to the present disclosure realizes automatic transition to the opening and closing position learning mode by any of the programs for the opening and closing position learning described above.

### 2. Embodiments

Preferred embodiments of the present disclosure will be described with reference to the accompanying drawings.

### 2.1. Configuration of the Valve Opening and Closing Position Detector

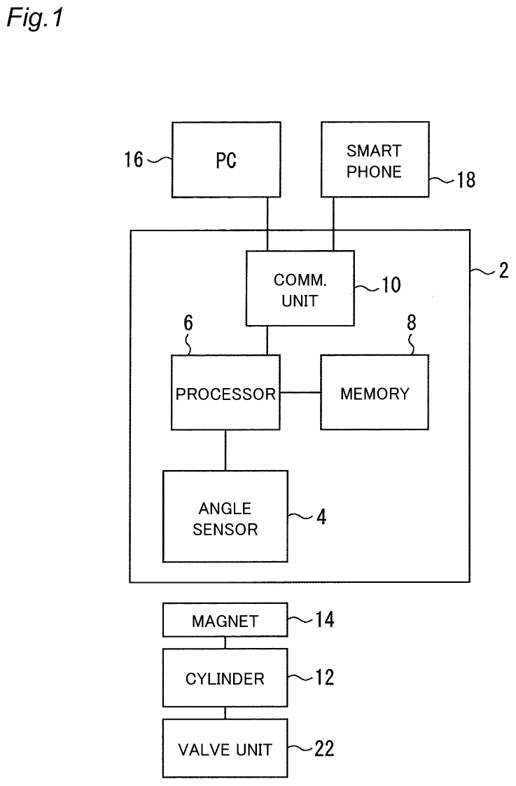

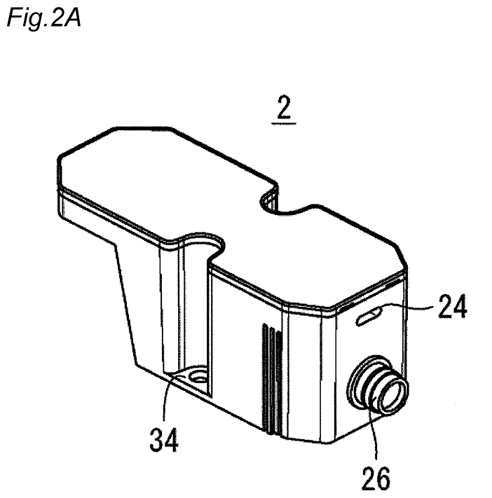

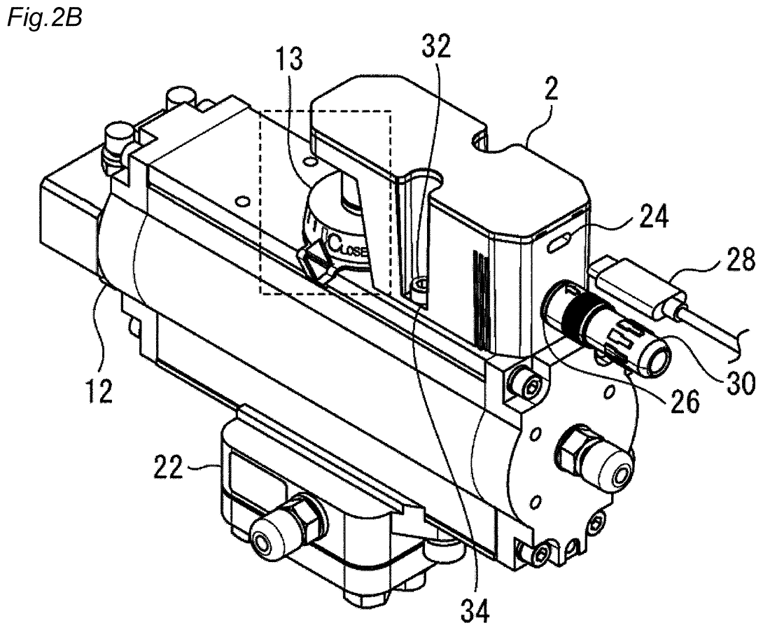

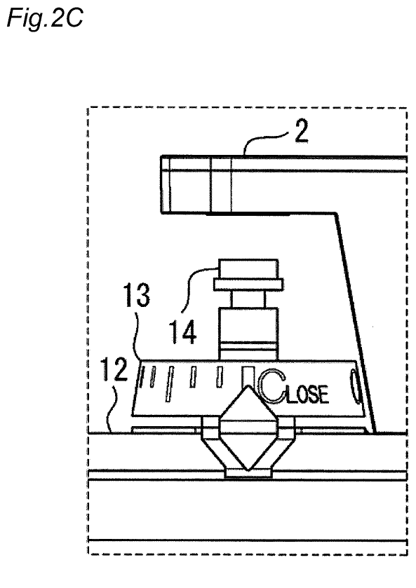

FIG. 1 is a block diagram illustrating a configuration of a valve opening and closing position detector 2 according to an embodiment and peripheral devices. As will be described later with reference to FIGS. 2A to 2C, the valve opening and closing position detector 2, which is the valve state monitoring device, is provided particularly on an upper part of a cylinder 12 for operating a valve body (valve) in a valve unit 22.

The valve opening and closing position detector 2 includes an angle sensor 4, a processor 6, a memory 8, and a communication unit 10.

An angle sensor 4 is a sensor that detects a rotational operation of a sensor magnet 14 provided on the upper part of the cylinder 12 (via an opening degree indicator unit 13) in a non-contact manner, and mainly includes a TMR element. Note that the sensor magnet 14 is configured to rotate via the opening degree indicator unit 13 illustrated in FIG. 3 in accordance with an operation of the cylinder 12 and further in accordance with a rotational operation of the valve in the valve unit 22. Therefore, the angle sensor 4 can detect an operation angle of the valve. The sensor magnet 14 is assumed to have mainly a ring shape, but may have another shape such as a rod shape or a fan shape. The angle sensor 4 here is a magnetic angle sensor forming a pair with the sensor magnet 14. A general angle sensor is not limited to a magnetic angle sensor. As the angle sensor it is possible to use, for example, an angle sensor using a potentiometer, an angle sensor using a rotary encoder, a gyro sensor that is an angular velocity sensor, or the like. The angle sensor 4 in the present disclosure is a magnetic angle sensor forming a pair with a magnet.

The processor 6 includes a central processing unit (CPU). Various functions of the valve opening and closing position detector 2 according to the present embodiment are implemented by the processor 6 executing various programs. Note that the various functions may be implemented by an application specific integrated circuit (ASIC) or the like, or may be implemented by a combination of an ASIC and a CPU or the like that loads various programs.

The memory 8 is a storage device in which data can be rewritten and that is inside the valve opening and closing position detector 2, and the memory 8 is configured with, for example, a random access memory (RAM) including a large number of semiconductor storage elements. The memory 8 temporarily stores a specific computer program, a variable value, a parameter value, and the like when the processor 6 executes various processes. For example, the memory 8 stores (valve) opening and closing trend data, angle profile data, histogram data, and operation data, which are intermediate data and result data of valve state monitoring, and stores various setting data.

Here, the (valve) opening and closing trend data is a collection of information indicating an operation status of the valve such as operation date and time, time required for the operation, an operation direction, an initial angle, or a final angle of the valve. The angle profile data is two-dimensional data indicated by plotting the angle of the valve on a vertical axis and (elapsed) time on a horizontal axis for a single operation of the valve (from a fully opened state to a fully closed state or from a fully closed state to a fully opened state). The angle profile data shows how the valve moved during an opening and closing operation.

The memory 8 may include a so-called read only memory (ROM). In the ROM, a computer program for implementing a process performed by the valve opening and closing position detector 2 to be described below is stored in advance. The processor 6 reads a computer program from the ROM and develops the computer program in the RAM, whereby the processor 6 can execute the computer program.

The communication unit 10 is a circuit that performs wired communication and/or wireless communication with the outside, and is an interface circuit that can output data to the outside, which includes various network terminals, a USB terminal, and the like, and can acquire data from the outside. The wired communication and the wireless communication include Bluetooth (registered trademark), RS485, USB, and the like. The intermediate data and the result data regarding the valve state monitoring can be transmitted to, for example, a personal computer (PC) 16 via a wired communication function of the communication unit 10. Similarly, intermediate data and result data regarding a valve state diagnosis can be transmitted to, for example, the smartphone 18 via a wireless communication function of the communication unit 10. The smartphone 18 may be a tablet terminal or the like.

Furthermore, a communication command can be transmitted from an external device such as the personal computer (PC) 16, the smartphone 18, or the tablet terminal to the processor 6 via the communication unit 10 by wired communication and wireless communication.

In the present embodiment, it is assumed that each process related to the valve open/close position detection is performed by the processor 6 of the valve opening and closing position detector 2.

FIG. 2A is a perspective view of the valve opening and closing position detector 2 according to the embodiment. FIG. 2B is a perspective view of a configuration containing the valve opening and closing position detector 2 according to the embodiment, the cylinder 12, and the valve unit 22. FIG. 2C is a partially enlarged view of the configuration in the broken-line frame illustrated in FIG. 2B. In particular, the partially enlarged view illustrates a relation between the valve opening and closing position detector 2 and the sensor magnet 14 having a ring shape provided on the upper part of the cylinder 12 via the opening degree indicator unit 13. In the valve opening and closing position detector 2 on an upper part of the sensor magnet 14, there are provided three layers constituting the magnetic angle sensor, that is, a magnetic film as a free layer, a nonmagnetic insulating film, and a magnetic film as a pin layer are provided from below (however, not illustrated).

Furthermore, as illustrated in FIG. 2B, the valve opening and closing position detector 2 includes a USB connection connector 24 and a power source and RS485 connection connector 26, which connectors are configured to be respectively connected to a USB communication cable 28 and an RS485 communication cable 30.

The valve opening and closing position detector 2 is attached, using attachment holes 34, to the cylinder 12 with screws 32 and screw holes in the upper part of the cylinder 12. The attachment holes 34, the screws 32, and the screw holes are each provided at least in a pair, but only one of each pair is illustrated in the perspective views of FIGS. 2A and 2B.

FIG. 3 is a top view of the cylinder 12. The ring-shaped sensor magnet 14, which is a sensor magnet, is attached to a rotary shaft on an upper part of the opening degree indicator unit 13 illustrated in the center of FIG. 3. As illustrated in FIG. 3, a position and direction of an S-pole and an N-pole of the sensor magnet 14 when attached to the rotary shaft of the opening degree indicator unit 13 are not constant but can vary.

### 2.2. Operation of the Valve Opening and Closing Position Detector

### 2.2.1. Process in the Opening and Closing Position Learning Mode

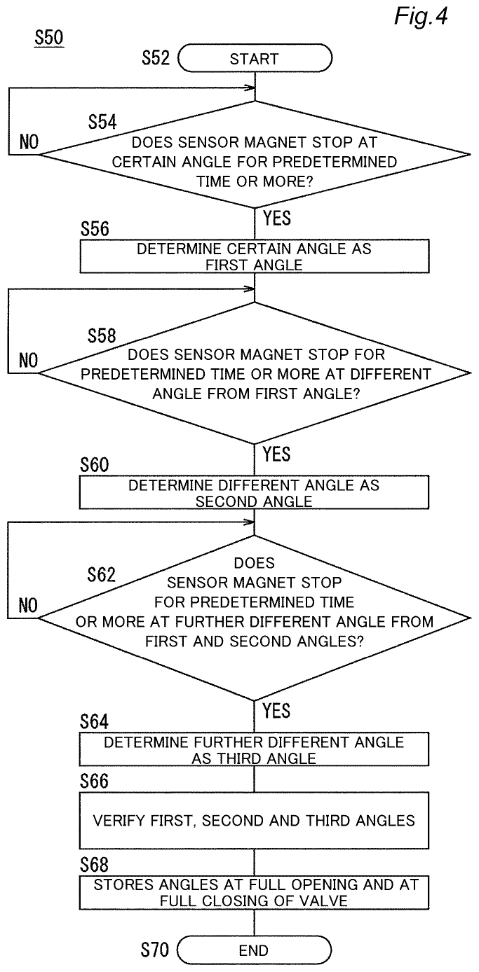

FIG. 4 is a flowchart of a process, in the opening and closing position learning mode, of the valve opening and closing position detector 2 according to the embodiment.

When the valve opening and closing position detector 2 enters the opening and closing position learning mode, the processor 6 starts executing a program for the opening and closing position learning (step S52). That is, the process illustrated in FIG. 4 is executed by the processor 6. The opening and closing position learning mode in the valve opening and closing position detector 2 is started by one of the following two cases.

(1) When the valve opening and closing position detector 2 receives a communication command transmitted from an external device such as the PC 16 or the smartphone 18 via a wireless or wired line.

(2) When a state where the angle sensor 4 cannot detect the sensor magnet 14 continues for a predetermined time.

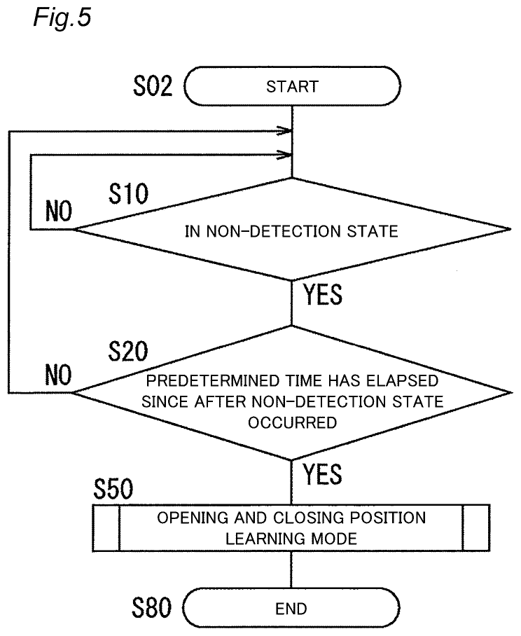

Above (1) is a manual transition in which a user inputs the communication command. Above (2) is an automatic (auto) transition for recovery of storage in the memory 8 in a case where it is assumed that the angle (position) of the sensor magnet 14 has changed. The position of the sensor magnet 14 changes, for example, when the valve is fully closed and/or fully opened. In particular, above (2) will be described in detail later with reference to FIG. 5.

When execution of the program for the opening and closing position learning is started (step S52), the processor 6 monitors the position of the sensor magnet 14, and determines whether an event has occurred in which the sensor magnet 14 stops at a certain angle (position) for a predetermined time or more (NO or YES in step S54). When it is determined that the event of stopping for a predetermined time or more has occurred (YES in step S54), the processor 6 temporarily stores the certain angle as a first angle (step S56).

After that, subsequently, the processor 6 determines whether an event has occurred in which the sensor magnet 14 stops for a predetermined time or more at a different angle (position) from the first angle (NO or YES in step S58). When the processor 6 determines that the event of stopping for the predetermined time or more has occurred (YES in step S58), the processor 6 temporarily stores the different angle as a second angle (step S60).

Thereafter, further subsequently, the processor 6 determines whether an event has occurred in which the sensor magnet 14 stops for a predetermined time or more at a further different angle (position) from the first angle and the second angle (step S62/NO or YES). When the processor 6 determines that the event of stopping for the predetermined time or more has occurred (YES in step S62), the processor 6 temporarily stores the further different angle as a third angle (step S64).

For the first angle, the second angle, and the third angle, the processor 6 verifies whether the angle is the angle when the valve is most open (that is, the angle when the valve is fully opened) or the angle when the valve is most closed (that is, the angle when the valve is fully closed) (step S66).

When the valve unit 22 is powered on, the valve may be stationary at a halfway position that is neither the fully open position nor the fully closed position. Therefore, in operation processing of the opening and closing position learning mode illustrated in the flowchart in FIG. 4, after three stationary states of the first angle, the second angle, and the third angle are confirmed and stored, the angle (position) at full opening of the valve and the angle (position) at full closing of the valve are determined by the verification.

The processor 6 stores in the memory 8 the determined angle (position) at full opening of the valve and the determined angle (position) at full closing of the valve (step S68), and ends the opening and closing position learning mode of the valve opening and closing position detector 2 (step S70).

The procedure of the process in the opening and closing position learning mode illustrated in FIG. 4 is an example. Another processing procedure may be used to determine the rotation angles of the sensor magnet 14 when the valve is fully opened and is fully closed and to record the rotation angles in the memory 8.

According to the flowchart of the process in the opening and closing position learning mode illustrated in FIG. 4 described above, in order to determine and store the angle (position) at full opening of the valve and the angle (position) at full closing of the valve, the processor 6 confirms the three stationary states of the first angle, the second angle, and the third angle, and then temporarily stores the information.

As described in the above [Background to the present disclosure], there is a valve in which it is assumed that the number of positions and angles to be grasped and stored as initial settings is, for example, M (M is a natural number of 2 or more). In the case of such a valve, the processor 6 can execute a process in the following order: processes [1] to [M+1], and a process [verification and storage].

The process [1]: the processor 6 determines whether an event has occurred in which the sensor magnet 14 stops at a certain angle (position) for a predetermined time or more. When the processor 6 determines that an event has occurred in which the sensor magnet 14 stops for a predetermined time or more, the processor 6 temporarily stores the angle of the stopped sensor magnet 14 as the first angle.

The process [2]: after that, subsequently, the processor 6 determines whether an event has occurred in which the sensor magnet 14 stops for a predetermined time or more at a different angle (position) from the first angle. When the processor 6 determines that the event has occurred in which the sensor magnet 14 stops for a predetermined time or more, the processor 6 temporarily stores the different angle as the second angle.

Such a process is repeatedly performed according to the value of M.

Process [M+1]: after that, further subsequently, the processor 6 determines whether an event has occurred in which the sensor magnet 14 stops for a predetermined time or more at a different angle (position) from any of the first angle to the M-th angle. When the processor 6 determines that the event has occurred in which the sensor magnet 14 stops for a predetermined time or more, the further different angle is temporarily stored to be an (M+1)-th angle.

The process [verification and storage]: the processor 6 verifies whether the angle or position corresponding to the opening and closing operation of the valve is indicated for each of the first angle to the (M+1)-th angle, and determines M angles or positions corresponding to the opening and closing of the valve. The determined data indicating the M angles or positions corresponding to the opening and closing of the valve is stored in the memory 8. This ends the opening and closing position learning mode for the valve in which the number of positions and angles to be grasped and stored as the initial setting is assumed to be M.

### 2.2.2. Procedure of the Automatic Recovery Learning Process

Next, an “automatic recovery learning process” will be described with reference to FIG. 5. FIG. 5 is a flowchart of a procedure of the automatic recovery learning process for automatically transitioning to the opening and closing position learning mode of the valve opening and closing position detector 2 according to the embodiment. After the start of the automatic recovery learning process (step S02), the processor 6 determines whether the angle sensor 4 is in a state (non-detection state) where the angle sensor 4 cannot detect the sensor magnet 14 in the first place (YES in step S10) or not (NO in step S10). When the processor 6 confirms the non-detection state (YES in step S10), the processor 6 stores data on an occurrence time of the non-detection state. Then, the processor 6 determines whether a predetermined time (for example, one second) has elapsed since the non-detection state occurred (YES in step S20) or not (NO in step S20).

When the processor 6 confirms that the angle sensor 4 is continuously in the non-detection state (YES in step S10) for a predetermined time or more (YES in step S20), the procedure automatically transits to the “opening and closing position learning mode” illustrated in FIG. 4 (step S50). When the “opening and closing position learning mode” ends, the processor 6 ends the procedure of the automatic recovery learning process (step S80). The “opening and closing position learning mode” here may be an operation mode for the “valve assumed to have M positions and angles to be grasped and stored as the initial settings” described above.

### 2.2.3. Situation in which the Automatic Recovery Learning Process is Necessary and Situation in which the Process Can Be Usefully Utilized

The situation in which the automatic recovery learning process is necessary is a situation in which the above-described state (2) where the angle sensor 4 cannot detect the sensor magnet 14 continues for a predetermined time. Furthermore, other than that, there is a situation in which it can be assumed that the angle (position) of the sensor magnet 14 has changed in response to the opening and closing of the valve. Specific examples thereof include the following case [1] to [3].

[1] A case where the valve opening and closing position detector 2 is detached, while being energized, from the cylinder 12 to which the sensor magnet 14 is attached.

[2] When the valve opening and closing position detector 2 is attached and energized without attaching the sensor magnet 14 to the cylinder 12.

[3] When the valve opening and closing position detector 2 is energized in a state where a magnetic field generated by the sensor magnet 14 cannot be detected.

Regarding above [1], even when the valve opening and closing position detector 2 is attached to the cylinder 12 again after being detached, it is assumed that the angle (position) of the valve opening and closing position detector 2 slightly changes. As a result, for example, when the valve is opened and closed, the position at full closing of the valve and the position at full opening of the valve can change. The reason why the positions are changed is that the attachment holes 34, the screws 32, and the screw holes have a slight allowance, a gap, or the like. Regarding above [2], for example, it is assumed that data on the angles (positions) of the sensor magnet 14 corresponding to the opening and closing of the valve were not stored before this situation. For example, a situation is assumed in which data when the valve is fully closed and when the valve is fully opened does not exist. In such a situation, it can be said that the automatic recovery learning process is necessary. Regarding above [3], the following situation can be assumed for example. An electromagnetic shield such as an iron plate or an iron piece is inserted between the sensor magnet 14 and the angle sensor 4, so that the angle sensor 4 cannot detect the magnetic field generated by the sensor magnet 14.

Furthermore, other situations are conceivable in which the automatic recovery learning process can be usefully utilized. Specifically, due to communication circumstances or from the viewpoint of information security, there is a situation in which wireless communication such as Bluetooth or wired communication such as USB or RS485 cannot be used, depending on the timing, in on-site equipment in which the valve is installed. In such a situation, first of all, the processor 6 cannot execute the program for the opening and closing position learning, by a communication command.

In such a situation, in order to simply execute the program for the opening and closing position learning, it is only required to intentionally create a state where the valve opening and closing position detector 2 cannot detect the magnetic field generated by the sensor magnet 14. Specifically, for example, when the following state [A] or state [B] is created, the automatic recovery learning process is performed.
[A] A state where the valve opening and closing position detector 2 is removed, while being energized, from the cylinder 12 to which the sensor magnet 14 is attached. This state is the same state as in the case of above [1].
[B] A state where the valve opening and closing position detector 2 is energized at a position away from the valve. This is a state included in the case of above [3].

In above [A], when the valve opening and closing position detector 2 is switched to the opening and closing position learning mode by a function of the automatic recovery learning, the processor 6 can execute the program for the opening and closing position learning even if the energization is turned off thereafter. At that time, the valve opening and closing position detector 2 may be brought into an energized state after attaching the valve opening and closing position detector 2 to the cylinder 12 again. Furthermore, in above [B], when the valve opening and closing position detector 2 is switched to the opening and closing position learning mode by a function of the automatic recovery learning, the processor 6 can execute the program for the opening and closing position learning even if the energization is turned off thereafter. At that time, similarly to above [A], the valve opening and closing position detector 2 may be brought into the energized state after attaching the valve opening and closing position detector 2 to the cylinder 12.

### 2.3. Summary of the Embodiment

The valve opening and closing position detector 2 according to the embodiment includes: a magnetic angle sensor 4 that detects an operation angle of a valve based on a magnetic field generated by a sensor magnet 14 that rotates in accordance with a rotational operation of the valve; and a processor 6. The processor 6 is configured to execute a program for learning opening and closing positions by storing in a memory 8 a plurality of angles of the sensor magnet 14 rotated in accordance with opening and closing operations of the valve. When a predetermined time has elapsed after an occurrence of a state in which the magnetic angle sensor 4 does not detect the sensor magnet 14, the processor 6 activates the program for learning the opening and closing position.

By using the valve opening and closing position detector 2 according to the embodiment, a valve state monitoring device for remotely monitoring a state of the valve can easily grasp an angle and position related to the opening and closing of the valve, for example, the angle and position at full closing of the valve and the angle and position at full opening of the valve.

### 3. Other Embodiments

As described above, an embodiment has been described as an example of the techniques disclosed in the present application. However, the techniques of the present disclosure can be applied not only to the above embodiment but also to an embodiment in which modification, replacement, addition, or removal is appropriately made.

In addition, the accompanying drawings and the detailed description have been provided in order to describe the embodiment. Therefore, the components illustrated in the accompanying drawings and described in the detailed description do not only include components essential for solving the problem but also can include, to exemplify the techniques, components that are not essential for solving the problem. For this reason, it should not be immediately recognized that those unnecessary components are necessary only because those unnecessary components are described in the accompanying drawings and the detailed description.

Furthermore, the above embodiments are for exemplifying the techniques according to the present disclosure; therefore, various modifications, replacements, additions, removals, or the like can be made without departing from the scope of the claims or the equivalent thereto.

1. A valve opening and closing position detector comprising:
a magnetic angle sensor that detects an operation angle of a valve based on a magnetic field generated by a magnet that rotates in accordance with a rotational operation of the valve;
a processor, and
a communication unit that receives a command from an external device,
wherein the processor is configured to execute a program for learning opening and closing positions by storing in a memory a plurality of angles of the magnet rotated in accordance with opening and closing operations of the valve,
wherein the processor activates the program for learning opening and closing positions in response to the processor receiving the communication command via the communication unit, and
wherein the processor activates the program for learning opening and closing positions in response to elapse of a predetermined time after an occurrence of a state in which the magnetic angle sensor does not detect the magnet, if the processor does not receive the communication command via the communication unit.

2. The valve opening and closing position detector according to claim 1, wherein the plurality of angles are three or more angles including an angle of the magnet at full opening of the valve and an angle of the magnet at full closing of the valve.

3. The valve opening and closing position detector according to claim 2, wherein the processor executing the program
determines, from the three or more angles, the angle at full opening of the valve and the angle at full closing of the valve, and
stores, in the memory, the angle at full opening and the angle at full closing.

4. The valve opening and closing position detector according to claim 3, wherein the processor executing the program
stores, in response to the magnet stopping at a first angle for the predetermined time or more, the first angle in the memory,
stores, in response to the magnet stopping at a second angle different from the first angle for the predetermined time or more, the second angle in the memory,
stores, in response to the magnet stopping at a third angle different from the first angle and the second angle for the predetermined time or more, the third angle in the memory, and
verifies which of the first angle, the second angle, and the third angle is the angle at full opening of the valve or the angle at full closing of the valve.

5. A method executed by a valve opening and closing position detector that activates a program for learning opening and closing positions of a valve by determining and storing in a memory a plurality of angles of a magnet rotated in accordance with opening and closing operations of the valve in response to reception of a communication command from an external device, the method comprising
causing, in response to elapse of a predetermined time after an occurrence of a state in which a magnetic angle sensor that detects an operation angle of the valve based on a magnetic field generated by the magnet that rotates in accordance with a rotational operation of the valve does not detect the magnet, a processor to activate the program for learning opening and closing positions.

6. The method according to claim 5, wherein the plurality of angles includes an angle of the magnet at full opening of the valve and an angle of the magnet at full closing of the valve.

7. The method according to claim 6, further comprising: causing the processor executing the program to
determine, from the plurality of angles, the angle at full opening of the valve and the angle at full closing of the valve, and
store, in the memory, the angle at full opening and the angle at full closing.

8. The method according to claim 7, further comprising:
causing, in response to the magnet stopping at a first angle for the predetermined time or more, the processor to perform a process to store the first angle in the memory;
causing, in response to the magnet stopping at a second angle different from the first angle for the predetermined time or more, the processor to perform a process to store the second angle in the memory;
causing, in response to the magnet stopping at a third angle different from the first angle and the second angle for the predetermined time or more, the processor to perform a process to store the third angle in the memory; and
causing the processor to verify which of the first angle, the second angle, and the third angle is the angle at full opening of the valve or the angle at full closing of the valve.

9. The valve opening and closing position detector according to claim 1,
wherein the valve opening and closing position detector and the magnet are each detachably attached to a cylinder attached to the valve for operating the valve, and
wherein the magnetic angle sensor is configured to be in a state of not detecting the magnet when the valve opening and closing position detector is detached from the cylinder to which the magnet is attached while the valve opening and closing position detector is energized, or when the valve opening and closing position detector is energized in a state where the magnet is not attached to the cylinder.
